(19) United States
(12) Patent Application Publication
(10) Pub. No.: US 2015/0316132 A1
(43) Pub. Date: Nov. 5, 2015

(54) STEPLESS TRANSMISSION

(71) Applicant: HONDA MOTOR CO., LTD., Tokyo (JP)

(72) Inventor: Yuji Nishimura, Saitama (JP)

(73) Assignee: HONDA MOTOR CO., LTD., Tokyo (JP)

(21) Appl. No.: 14/647,892

(22) PCT Filed: Feb. 7, 2014
(86) PCT No.: PCT/JP2014/052938

§ 371 Date: May 28, 2015

(30) Foreign Application Priority Data
Mar. 29, 2013 (JP) 2013-075103

(51) Int. Cl. F16H 29/04

(52) U.S. Cl. CPC F16H 29/04

(57) ABSTRACT

A one-way clutch 17 in a stepless transmission 1 locks a swing link 18 to an output shaft 3 when a swing end 18a moves away from an input shaft 2. The distance Lcon between an input-side fulcrum P3 and an output-side fulcrum P5 satisfies the following conditional expression:

Lcon<√(Lp²+R1²−R2²)

where Lp is the distance between the rotational center axis P1 of the input shaft and the rotational center axis P4 of the output shaft, R1 is the distance between the rotational center axis P1 of the input shaft and the input-side fulcrum P3 when the amount of eccentricity of a rotational radius adjusting mechanism 4 is a predetermined value, and R2 is the distance between the rotational center axis P4 of the output shaft and the output-side fulcrum P5.

### TECHNICAL FIELD

The present invention relates to a four-joint link mechanism type stepless transmission using a lever crank mechanism.

### BACKGROUND ART

A four-joint link mechanism type stepless transmission has been conventionally known. The four-joint link mechanism type stepless transmission includes: an input shaft to which a drive force from a drive source such as an engine is transmitted; an output shaft disposed in parallel with the input shaft; and a plurality of lever crank mechanisms (for example, see Patent Document 1).

In the stepless transmission described in Patent Document 1, each lever crank mechanism includes: a rotational radius adjusting mechanism rotatable about the input shaft and having an adjustable rotational radius; a swing link pivotally supported by the output shaft; and a connecting rod one end of which is externally fitted to the rotational radius adjusting mechanism so as to be rotatable and the other end of which is connected to the swing end of the swing link.

A one-way clutch as a one-way rotation blocking mechanism is provided between the swing link and the output shaft. The one-way clutch locks the swing link to the output shaft when the swing link tries to rotate to one side about the output shaft, and lets the swing link idle with respect to the output shaft when the swing link tries to rotate to the other side.

The rotational radius adjusting mechanism includes: a disc-shaped rotary portion having a through hole pierced eccentrically; a ring gear provided on the inner peripheral surface of the through hole; a first pinion fixed to the input shaft and meshing with the ring gear; a carrier to which a drive force from an adjustment drive source is transmitted; and two second pinions each of which is pivotally supported by the carrier so as to be rotatable and revolvable and meshes with the ring gear. The first pinion and the two second pinions are arranged so that the triangle defined by their centers as vertices is an equilateral triangle.

In the rotational radius adjusting mechanism, in the case where the rotational speed of the input shaft rotated by the travel drive source and the rotational speed of the carrier rotated by the adjustment drive source are the same, the amount of eccentricity of the center of the rotary portion with respect to the rotational center axis of the input shaft is maintained, and the rotational radius of the rotational radius adjusting mechanism is kept constant. In the case where the rotational speed of the input shaft and the rotational speed of the carrier are different, on the other hand, the amount of eccentricity of the center of the rotary portion with respect to the rotational center axis of the input shaft changes, and the rotational radius of the rotational radius adjusting mechanism changes, too.

The rotational radius adjusting mechanism thus has its rotational radius changed to change the swing amplitude of the swing end of the swing link and change the transmission gear ratio, thereby controlling the rotational speed of the output shaft relative to the rotational speed of the input shaft.

In the stepless transmission, by setting the distance between the center of the equilateral triangle defined by the centers of the three pinions as its vertices and the rotational center axis of the input shaft to be equal to the distance between the center of the equilateral triangle and the center of the rotary portion, the amount of eccentricity can be set to 0 with the rotational center axis of the input shaft and the center of the rotary portion coinciding with each other. In the case where the amount of eccentricity is 0, the swing amplitude of the swing end of the swing link is 0 even when the input shaft is rotating, so that the output shaft is not in rotation.

In the lever crank mechanism in the stepless transmission, the carrier and the second pinions constitute a cam portion to which the drive force from the adjustment drive source is transmitted.

The cam portions in the respective lever crank mechanisms differ in phase from each other so that the plurality of cam portions form a circle around the input shaft in the circumferential direction. The connecting rods externally fitted to the respective rotational radius adjusting mechanisms at one end cause the respective swing links to transmit torques to the output shaft in order, thus rotating the output shaft.

### CITATION LIST

### Patent Literature

Patent Literature 1: Japanese Patent Application Laid-open No. 2012-1048

### SUMMARY OF INVENTION

### Technical Problem

The lever crank mechanism in the stepless transmission described above is used in combination with the one-way clutch to transmit the torque to the output shaft only when the swing link swings to one side.

Accordingly, in the case where the swing link swings hard, there is a possibility that vibrations occur or the connecting point between the swing link and the connecting rod is overloaded.

The present invention has been made in view of the above, and has an object of providing a stepless transmission that can suppress vibrations and overload.

### Solution to Problem

A stepless transmission according to the present invention is a stepless transmission including: an input shaft to which a drive force of a drive source is transmitted; an output shaft disposed in parallel with the input shaft; a lever crank mechanism that includes: a rotational radius adjusting mechanism rotatable about the input shaft and having an adjustable rotational radius; a swing link pivotally supported by the output shaft; and a connecting rod connecting the rotational radius adjusting mechanism and the swing link, and that converts rotational motion of the input shaft into swing motion of a swing end of the swing link; and a one-way rotation blocking mechanism that locks the swing link to the output shaft when the swing link rotates about the output shaft so that the swing end moves away from the input shaft, and lets the swing link idle with respect to the output shaft when the swing link rotates so that the swing end moves toward the input shaft, wherein a distance Lcon between a connecting point between the rotational radius adjusting mechanism and the connecting rod and a connecting point between the swing end and the connecting rod satisfies the following conditional expression (1).

Lcon<√(Lp²+R1²−R2²) (1)

where Lp is a distance between a rotational center axis of the input shaft and a rotational center axis of the output shaft, R1 is a distance between the rotational center axis of the input shaft and an input-side fulcrum when an amount of eccentricity of the rotational radius adjusting mechanism is a predetermined amount of eccentricity, and R2 is a distance between the rotational center axis of the output shaft and an output-side fulcrum, the input-side fulcrum being the connecting point between the rotational radius adjusting mechanism and the connecting rod, and the output-side fulcrum being the connecting point between the swing end and the connecting rod.

According to the present invention, Lcon satisfies the conditional expression (1), so that the angle between the swing link and the connecting rod is a right angle when the maximum load acts on the connecting point (i.e. the output-side fulcrum) between the swing link and the connecting rod.

Therefore, the force applied to the swing link by the connecting rod at the time does not disperse in multiple directions and so vibrations can be suppressed, and also the output-side fulcrum can be prevented from being overloaded.

Preferably, in the stepless transmission according to the present invention, the distance Lcon between the connecting point between the rotational radius adjusting mechanism and the connecting rod and the connecting point between the swing end and the connecting rod satisfies the following conditional expression (2).

√(Lp²−R2²)−R1≦Lcon (2).

If the conditional expression (2) is satisfied in addition to the conditional expression (1), the length of the connecting rod is appropriate regardless of the properties of the other members, such as the one-way clutch, constituting the stepless transmission.

Preferably, in the stepless transmission according to the present invention, the predetermined amount of eccentricity is an amount of eccentricity when a torque transmitted to the output shaft is maximum. This structure can effectively reduce the load in the state where the load is largest.

Preferably, the stepless transmission according to the present invention includes a plurality of the lever crank mechanisms, and the predetermined amount of eccentricity is an amount of eccentricity when a transmission gear ratio is minimum, from among amounts of eccentricity when a torque transmitted to the output shaft is maximum. This structure can effectively reduce the load in the state where the load shared per lever crank mechanism is largest.

### BRIEF DESCRIPTION OF DRAWINGS

FIG. 1 is a sectional diagram illustrating an embodiment of a stepless transmission according to the present invention.

FIG. 2 is a schematic diagram illustrating a rotational radius adjusting mechanism, a connecting rod, and a swing link in the stepless transmission in FIG. 1 from the axial direction.

FIGS. 3A to 3D are schematic diagrams illustrating changes in rotational radius of the rotational radius adjusting mechanism in the stepless transmission in FIG. 1.

FIGS. 4A to 4C are schematic diagrams illustrating the relationship between the changes in rotational radius of the rotational radius adjusting mechanism and the swing angle of the swing motion of the swing link in the stepless transmission in FIG. 1, where FIG. 4A illustrates the swing angle of the swing motion of the swing link in the case where the rotational radius is maximum, FIG. 4B illustrates the swing angle of the swing motion of the swing link in the case where the rotational radius is medium, and FIG. 4C illustrates the swing angle of the swing motion of the swing link in the case where the rotational radius is small.

FIG. 5 is a graph illustrating changes in angular velocity of the swing link with respect to changes in rotational radius of the rotational radius adjusting mechanism in the stepless transmission in FIG. 1.

FIGS. 6A to 6E are schematic diagrams illustrating the operation of the lever crank mechanism in the case where the output shaft is rotating at a predetermined angular velocity in the stepless transmission in FIG. 1, where FIG. 6A illustrates the state in which the swing end is at an inner dead point, FIG. 6B illustrates the state in which the swing end is at a meshing point, FIG. 6C illustrates the state in which the swing end is at a maximum angular velocity point, FIG. 6D illustrates the state in which the swing end is at a maximum load point, and FIG. 6E illustrates the state in which the swing end is at an outer dead point.

FIG. 7 is a graph illustrating changes in angular velocity of the input shaft and the output shaft in the states illustrated in FIG. 6 in the stepless transmission in FIG. 1.

FIGS. 8A to 8C are schematic diagrams illustrating the operation of the lever crank mechanism in the case where the output shaft is not rotating in the stepless transmission in FIG. 1, where FIG. 8A illustrates the state in which the swing end is at the inner dead point (the meshing point), FIG. 8B illustrates the state in which the swing end is at the maximum angular velocity point, and FIG. 8C illustrates the state in which the swing end is at the outer dead point (the maximum load point).

FIG. 9 is a graph illustrating changes in angular velocity of the output shaft with respect to changes in angular velocity of the input shaft in the states illustrated in FIG. 8 in the stepless transmission in FIG. 1.

FIG. 10 is a graph illustrating changes in output shaft torque with respect to changes in rotational radius of the rotational radius adjusting mechanism in the stepless transmission in FIG. 1.

FIGS. 11A and 11B are graphs illustrating changes in output shaft torque in the stepless transmission in FIG. 1, where FIG. 11A illustrates the state in which the rotational radius of the rotational radius adjusting mechanism is R1a in the graph in FIG. 10, and FIG. 11B illustrates the state in which the rotational radius of the rotational radius adjusting mechanism is R1b in the graph in FIG. 10.

### DESCRIPTION OF EMBODIMENTS

The following describes an embodiment of a stepless transmission according to the present invention. The stepless transmission in this embodiment is a four-joint link mechanism type stepless transmission, and is an infinitely variable transmission (IVT), i.e. a type of transmission capable of setting the transmission gear ratio i (i=(the rotational speed of an input shaft)/(the rotational speed of an output shaft)) to infinity (∞) to set the rotational speed of the output shaft to 0.

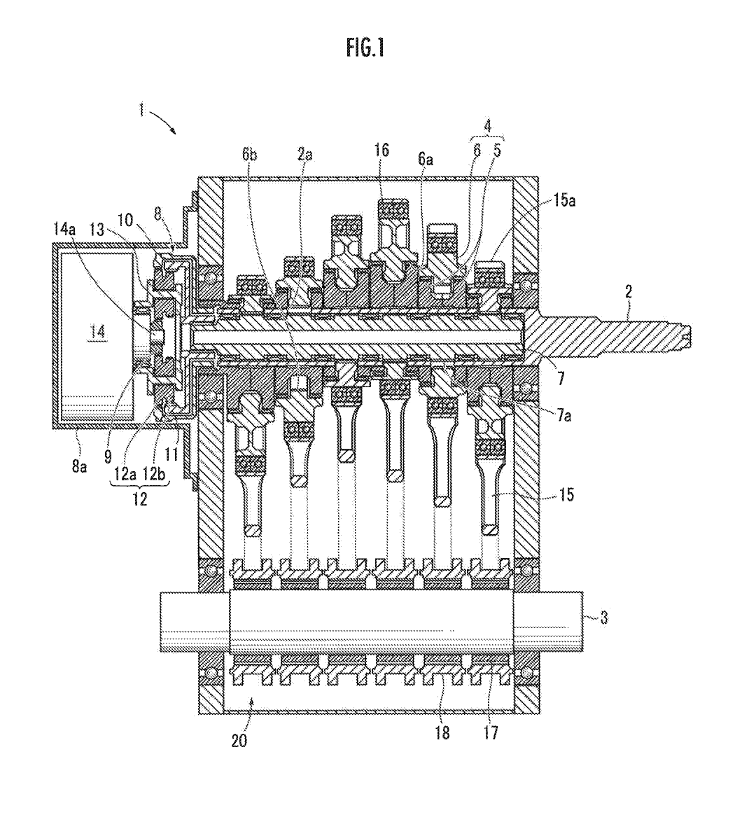

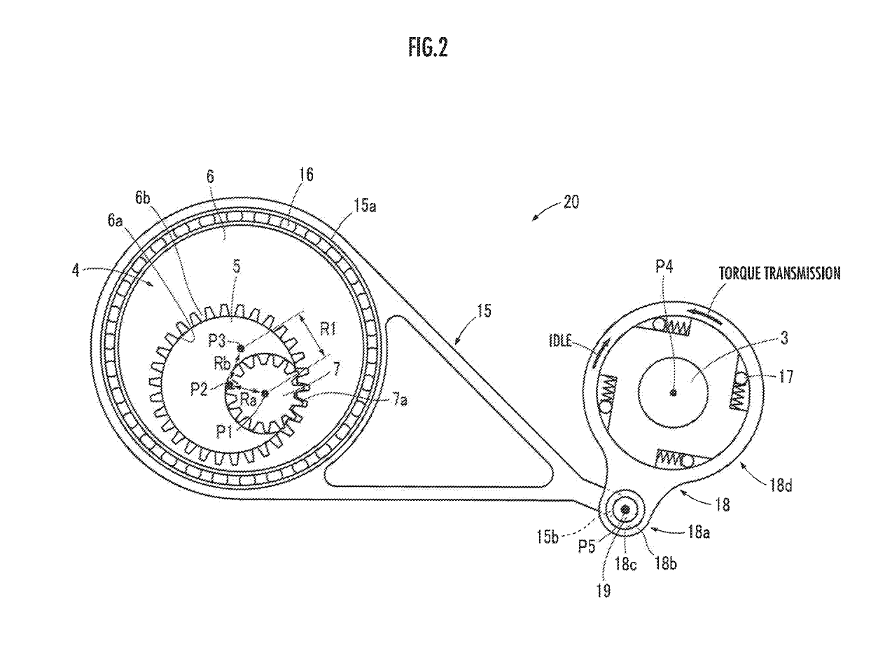

The structure of the stepless transmission in this embodiment is described first, with reference to FIGS. 1 and 2.

A stepless transmission 1 in this embodiment includes an input shaft 2, an output shaft 3, and six rotational radius adjusting mechanisms 4.

The input shaft 2 is a hollow member, and rotates about the rotational center axis P1 of the input shaft 2 with a rotational drive force received from a drive source such as an engine which is an internal-combustion engine or an electric motor.

The output shaft 3 is disposed in parallel with the input shaft 2 at a position horizontally away from the input shaft 2, and transmits rotational motive power to drive portions such as drive wheels and the like of a vehicle through a differential gear, a propeller shaft, etc. not illustrated.

Each rotational radius adjusting mechanism 4 is provided to rotate about the rotational center axis P1 of the input shaft 2, and includes cam discs 5 as a cam portion, a rotary disc 6 as a rotary portion, and a pinion shaft 7.

The cam discs 5 are disc-shaped. Each pair of cam discs 5 are provided on the input shaft 2 so as to rotate integrally with the input shaft 2 in a state of being eccentric with respect to the rotational center axis P1 of the input shaft 2. The pairs of cam discs 5 have their phases shifted by 60° from each other, and are arranged so that the six pairs of cam discs 5 form a circle around the input shaft 2 in the circumferential direction.

The rotary disc 6 is disc-shaped, and has a receiving hole 6a at an eccentric position. The rotary disc 6 is externally fitted to each of the pair of cam discs 5 via the receiving hole 6a so as to be rotatable.

The center of the receiving hole 6a of the rotary disc 6 is situated so that the distance Ra from the rotational center axis P1 of the input shaft 2 to the center P2 of the cam discs 5 (the center of the receiving hole 6a) and the distance Rb from the center P2 of the cam discs 5 to the center P3 of the rotary disc 6 are the same. The rotary disc 6 has internal teeth 6b in the receiving hole 6a, at the position between the pair of cam discs 5.

The pinion shaft 7 is disposed in the hollow input shaft 2 concentrically with the input shaft 2, and is rotatable relative to the input shaft 2. The pinion shaft 7 has external teeth 7a on its outer periphery. The pinion shaft 7 is connected with a differential mechanism 8.

The input shaft 2 has a cutout hole 2a that is positioned between the pair of cam discs 5 and provides communication between an inner peripheral surface and an outer peripheral surface at a location opposing the eccentric direction of the cam discs 5. The external teeth 7a provided on the outer periphery of the pinion shaft 7 mesh with the internal teeth 6b provided on the inner periphery of the receiving hole 6a of the rotary disc 6, via the cutout hole 2a of the input shaft 2.

The differential mechanism 8 is formed as a planetary gear mechanism, and includes: a sun gear 9; a first ring gear 10 connected to the input shaft 2; a second ring gear 11 connected to the pinion shaft 7; and a carrier 13 that pivotally supports, in a rotatable and revolvable manner, a stepped pinion 12 composed of a large-diameter section 12a that meshes with the sun gear 9 and the first ring gear 10 and a small-diameter section 12b that meshes with the second ring gear 11. The sun gear 9 in the differential mechanism 8 is connected to a rotating shaft 14a of an adjustment drive source 14 composed of an electric motor for the pinion shaft 7.

In the case where the rotational speed of the adjustment drive source 14 and the rotational speed of the input shaft 2 are the same, the sun gear 9 and the first ring gear 10 rotate at the same speed, and the four elements, namely, the sun gear 9, the first ring gear 10, the second ring gear 11, and the carrier 13, are put in a locked state in which relative rotation is disabled. As a result, the pinion shaft 7 connected to the second ring gear 11 rotates at the same speed as the input shaft 2.

In the case where the rotational speed of the adjustment drive source 14 is lower than the rotational speed of the input shaft 2, the number of rotations of the carrier 13 is (j·NR1+Ns)/(j+1), where Ns is the number of rotations of the sun gear 9, NR1 is the number of rotations of the first ring gear 10, and j is the gear ratio of the sun gear 9 and the first ring gear 10 ((the number of teeth of the first ring gear 10)/(the number of teeth of the sun gear 9)). Further, the number of rotations of the second ring gear 11 is {j(k+1)NR1+(k−j)Ns}/{k(j+1)}, where k is the gear ratio of the sun gear 9 and the second ring gear 11 ((the number of teeth of the second ring gear 11)/(the number of teeth of the sun gear 9)×(the number of teeth of the large-diameter section 12a of the stepped pinion 12)/(the number of teeth of the small-diameter section 12b of the stepped pinion 12)).

Thus, in the case where the rotational speed of the adjustment drive source 14 is lower than the rotational speed of the input shaft 2 and the rotational speed of the input shaft 2 to which the cam discs 5 are fixed and the rotational speed of the pinion shaft 7 are the same, the rotary disc 6 rotates integrally with the cam discs 5. In the case where the rotational speed of the input shaft 2 and the rotational speed of the pinion shaft 7 are different, on the other hand, the rotary disc 6 rotates around the peripheral edges of the cam discs 5 about the center P2 of the cam discs 5.

The rotary disc 6 is eccentric with respect to the cam discs 5 so that the distance Ra between P1 and P2 and the distance Rb between P2 and P3 are the same, as illustrated in FIG. 2. Hence, the center P3 of the rotary disc 6 can be positioned on the same axis as the rotational center axis P1 of the input shaft 2 to set the distance between the rotational center axis P1 of the input shaft 2 and the center P3 of the rotary disc 6, i.e. the amount of eccentricity R1, to 0.

A connecting rod 15 is externally fitted to the rotational radius adjusting mechanism 4 and in particular the peripheral edges of the rotary disc 6 of the rotational radius adjusting mechanism 4 so as to be rotatable.

The connecting rod 15 has a large-diameter annular section 15a having a large diameter at one end, and a small-diameter annular section 15b smaller in diameter than the large-diameter annular section 15a at the other end. The large-diameter annular section 15a of the connecting rod 15 is externally fitted to the rotary disc 6 via a connecting rod bearing 16 made up of ball bearings.

Each swing link 18 is pivotally supported by the output shaft 3 through a one-way clutch 17 as a one-way rotation blocking mechanism.

The one-way clutch 17 locks the swing link 18 to the output shaft 3 when the swing link 18 tries to rotate to one side about the rotational center axis P4 of the output shaft 3, and lets the swing link 18 idle with respect to the output shaft 3 when the swing link 18 tries to rotate to the other side.

The swing link 18 has a swing end 18a. The swing end 18a has a pair of protruding pieces 18b formed to be able to sandwich the small-diameter annular section 15b in the axial direction. The pair of protruding pieces 18b have a through hole 18c corresponding to the inside diameter of the small-diameter annular section 15b. A connecting pin 19 is inserted into the through hole 18c and the small-diameter annular section 15b, thus connecting the connecting rod 15 and the swing link 18. The swing link 18 also has an annular section 18d.

The one-way clutch 17 is formed with the annular section 18d as an outer member and the output shaft 3 as an inner member.

The following describes a lever crank mechanism in the stepless transmission in this embodiment, with reference to FIGS. 1 to 5.

In the stepless transmission 1 in this embodiment, the rotational radius adjusting mechanism 4, the connecting rod 15, and the swing link 18 constitute a lever crank mechanism 20 (four-joint link mechanism), as illustrated in FIG. 2.

The lever crank mechanism 20 converts the rotational motion of the input shaft 2 into the swing motion of the swing link 18 about the rotational center axis P4 of the output shaft 3. The stepless transmission 1 in this embodiment includes a total of six lever crank mechanisms 20, as illustrated in FIG. 1.

In these lever crank mechanisms 20, when the input shaft 2 and the pinion shaft 7 are rotated at the same speed in the case where the amount of eccentricity R1 of the rotational radius adjusting mechanism 4 is not 0, each connecting rod 15 repeatedly alternates between pushing the swing end 18a toward the output shaft 3 and pulling the swing end 18a toward the input shaft 2 between the input shaft 2 and the output shaft 3 while shifting the phase by 60°, to swing the swing link 18.

The one-way clutch 17 is provided between the swing link 18 and the output shaft 3. Accordingly, when the swing link 18 is pushed, the swing link 18 is locked and the force of the swing motion of the swing link 18 is transmitted to the output shaft 3, as a result of which the output shaft 3 rotates. When the swing link 18 is pulled, the swing link 18 idles and the force of the swing motion of the swing link 18 is not transmitted to the output shaft 3. The six rotational radius adjusting mechanisms 4 have their phases shifted by 60°, so that the output shaft 3 is rotated by the six rotational radius adjusting mechanisms 4 in order.

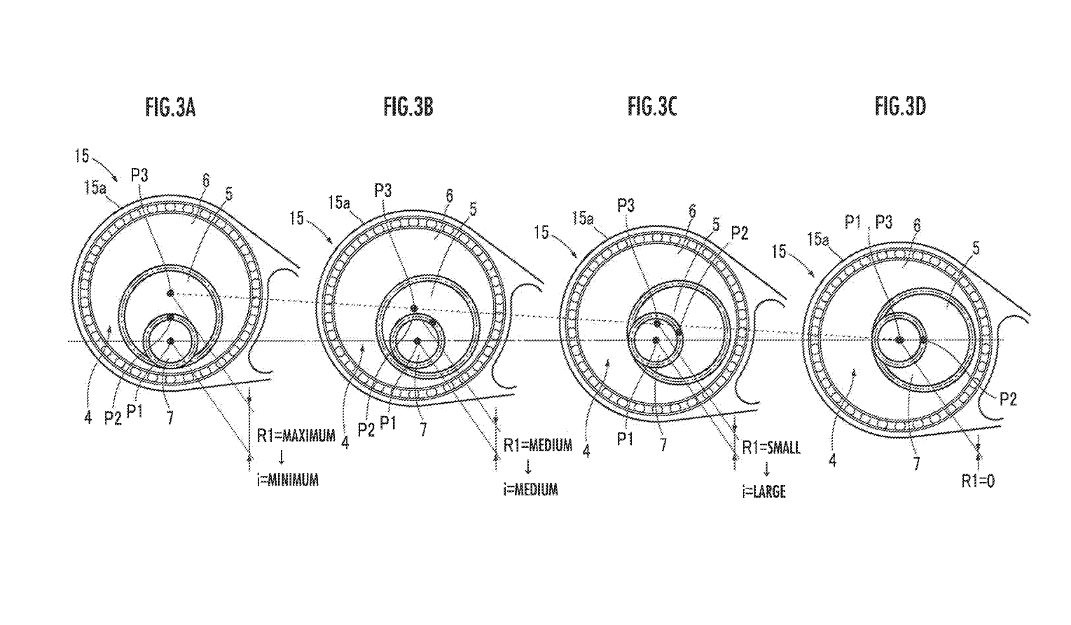

In the stepless transmission 1 in this embodiment, the rotational radius of the rotational radius adjusting mechanism 4 can be adjusted by changing the amount of eccentricity R1, as illustrated in FIGS. 3A to 3D.

FIG. 3A illustrates the state in which the amount of eccentricity R1 is “maximum”. The pinion shaft 7 and the rotary disc 6 are positioned so that the rotational center axis P1 of the input shaft 2, the center P2 of the cam discs 5, and the center P3 of the rotary disc 6 (the input-side fulcrum) lie on a straight line. The transmission gear ratio i in this case is minimum. FIG. 3B illustrates the state in which the amount of eccentricity R1 is “medium,” which is smaller than that in FIG. 3A. FIG. 3C illustrates the state in which the amount of eccentricity R1 is “small,” which is smaller than that in FIG. 3B. The transmission gear ratio i in FIG. 3B is “medium,” which is larger than the transmission gear ratio i in FIG. 3A. The transmission gear ratio i in FIG. 3C is “large,” which is larger than the transmission gear ratio i in FIG. 3B. FIG. 3D illustrates the state in which the amount of eccentricity R1 is “0”, where the rotational center axis P1 of the input shaft 2 and the center P3 of the rotary disc 6 (the input-side fulcrum) are concentric. The transmission gear ratio i in this case is infinity (∞).

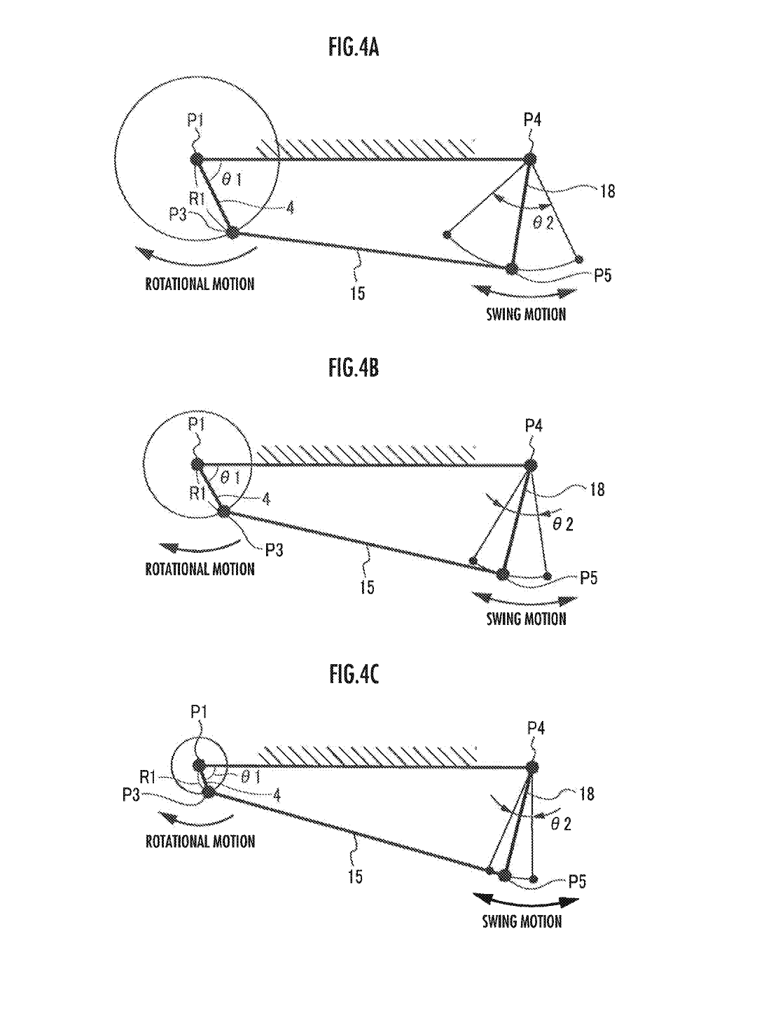

FIGS. 4A to 4C are schematic diagrams illustrating the relationship between the changes in rotational radius of the rotational radius adjusting mechanism 4, i.e. the changes in amount of eccentricity R1, and the swing angle of the swing motion of the swing link 18 in this embodiment.

FIG. 4A illustrates the swing range θ2 of the swing link 18 with respect to the rotational motion of the rotational radius adjusting mechanism 4 in the case where the amount of eccentricity R1 is “maximum” in FIG. 3A (the transmission gear ratio i is minimum). FIG. 4B illustrates the swing range θ2 of the swing link 18 with respect to the rotational motion of the rotational radius adjusting mechanism 4 in the case where the amount of eccentricity R1 is “medium” in FIG. 3B (the transmission gear ratio i is medium). FIG. 4C illustrates the swing range θ2 of the swing link 18 with respect to the rotational motion of the rotational radius adjusting mechanism 4 in the case where the amount of eccentricity R1 is “small” in FIG. 3C (the transmission gear ratio i is large). Here, the distance from the rotational center axis P4 of the output shaft 3 to the connecting point between the connecting rod 15 and the swing end 18a, i.e. the center P5 of the connecting pin 19 (the output-side fulcrum), is the length R2 of the swing link 18.

It can be understood from FIGS. 4A to 4C that the swing range θ2 of the swing link 18 is narrower when the amount of eccentricity R1 is smaller. In the case where the amount of eccentricity R1 is “0”, the swing link 18 stops swinging.

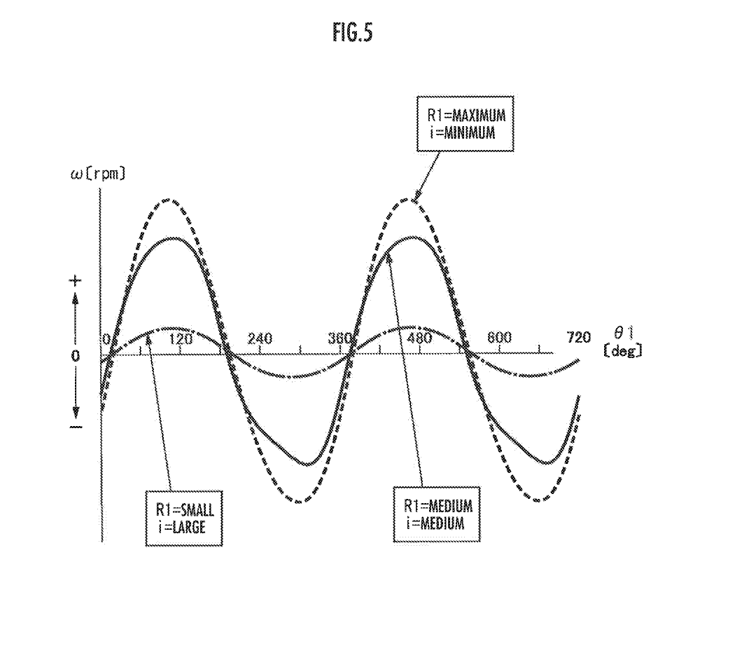

FIG. 5 is a diagram illustrating the relationship of the changes of the angular velocity ω of the swing link 18 to the changes of the amount of eccentricity R1 of the rotational radius adjusting mechanism 4 in the stepless transmission 1. The horizontal axis represents the rotational angle θ1 of the rotational radius adjusting mechanism 4, and the vertical axis represents the angular velocity ω of the swing link 18.

As is clear from FIG. 5, the angular velocity ω of the swing link 18 is larger when the amount of eccentricity R1 is larger (the transmission gear ratio i is smaller).

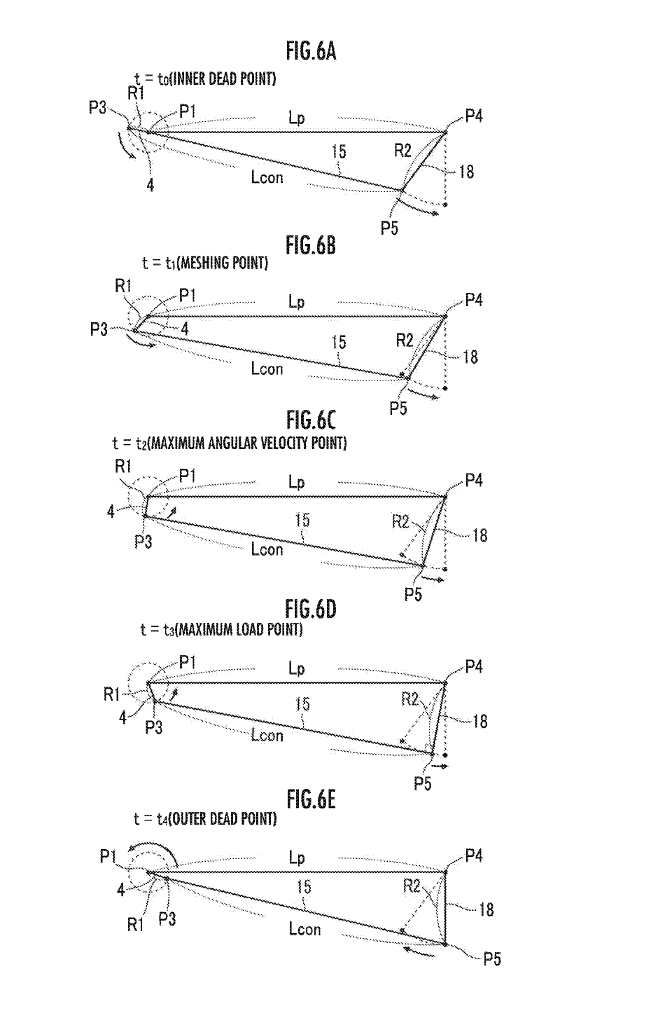

The following describes the lever crank mechanism 20 in the stepless transmission 1 in this embodiment in detail, with reference to FIGS. 6 to 11.

In the stepless transmission 1 in this embodiment, the rotational motion of the center P3 of the rotary disc 6 (the input-side fulcrum) is converted into the swing motion of the connecting point between the swing end 18a of the swing link 18 and the connecting rod 15, i.e. the center P5 of the connecting pin 19 (the output-side fulcrum), through the connecting rod 15 whose length is Lcon, as illustrated in FIGS. 6A to 6E.

The center of the rotational motion is the rotational center axis P1 of the input shaft 2, and the radius of the rotational motion is the amount of eccentricity R1 of the rotational radius adjusting mechanism 4. The center of the swing motion is the rotational center axis P4 of the output shaft 3, and the radius of the swing motion is the distance R2 from the center P5 of the connecting pin 19 (the output-side fulcrum) to the rotational center axis P4 of the output shaft 3.

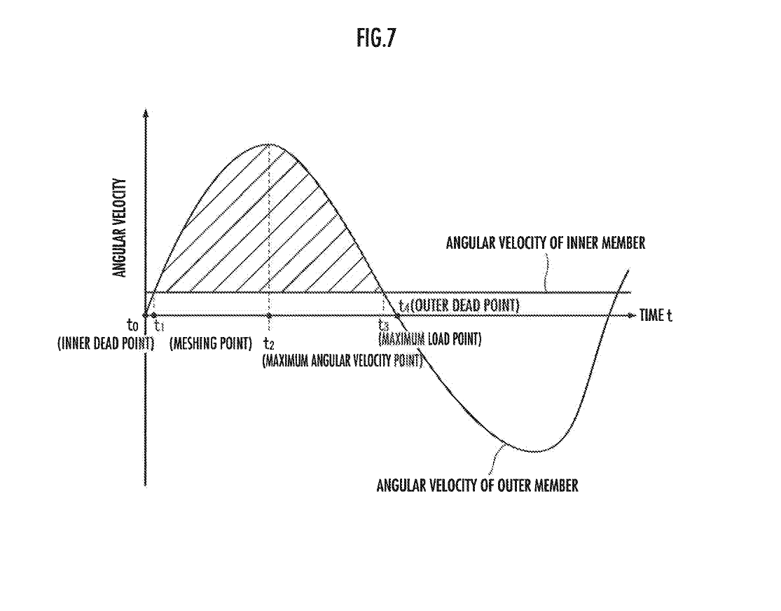

The operation of the lever crank mechanism 20 in the case where the angular velocity of the output shaft 3 which is the inner member of the one-way clutch 17 is constant is described below, with reference to FIGS. 6A to 6E and 7.

First, as illustrated in FIG. 6A, when the center P3 of the rotary disc 6 (the input-side fulcrum) starts rotational motion, the center P5 of the connecting pin 19 (the output-side fulcrum) starts to move from the position (hereafter referred to as “inner dead point”) closest to the input shaft 2 in the swing range of the swing rink 18 in the direction away from the input shaft 2, and the angular velocity of the annular section 18d of the swing rink 18 which is the outer member of the one-way clutch starts to increase. This is the state when t=t0 in FIG. 7.

Next, as illustrated in FIG. 6B, when the center P3 of the rotary disc 6 (the input-side fulcrum) rotates to a certain extent, the center P5 of the connecting pin 19 (the output-side fulcrum) reaches the position (hereafter referred to as “meshing point”) at which the angular velocity of the annular section 18d of the swing rink 18 which is the outer member of the one-way clutch 17 has increased to the same level as the angular velocity of the output shaft 3 which is the inner member of the one-way clutch 17, and the torque transmission to the output shaft 3 starts. This is the state when t=t1 in FIG. 7.

Next, as illustrated in FIG. 6C, when the center P3 of the rotary disc 6 (the input-side fulcrum) further rotates, the center P5 of the connecting pin 19 (the output-side fulcrum) reaches the position (hereafter referred to as “maximum angular velocity point”) at which the angular velocity of the annular section 18d of the swing rink 18 which is the outer member of the one-way clutch is maximum, and the angular velocity of the annular section 18d starts to decrease. This is the state when t=t2 in FIG. 7.

Next, as illustrated in FIG. 6D, when the center P3 of the rotary disc 6 (the input-side fulcrum) further rotates, the center P5 of the connecting pin 19 (the output-side fulcrum) reaches the position (hereafter referred to as “maximum load point”) at which the angular velocity of the annular section 18d of the swing rink 18 which is the outer member of the one-way clutch 17 has decreased to the same level as the angular velocity of the output shaft 3 which is the inner member of the one-way clutch 17, and the cumulative value (the hatched area in FIG. 7) of the torque transmitted to the output shaft 3 reaches a maximum. This is the state when t=t3 in FIG. 7.

Next, as illustrated in FIG. 6E, when the center P3 of the rotary disc 6 (the input-side fulcrum) further rotates, the center P5 of the connecting pin 19 (the output-side fulcrum) reaches the position (hereafter referred to as “outer dead point”) farthest from the input shaft 2 in the swing range of the swing link 18 and starts to move in the direction toward the input shaft 2, and the angular velocity of the annular section 18d of the swing rink 18 which is the outer member of the one-way clutch starts to increase in the negative direction. This is the state when t=t4 in FIG. 7.

Subsequently, the center P3 of the rotary disc 6 (the input-side fulcrum) further rotates and the states in FIGS. 6A to 6E are repeated to perform the swing motion of the swing link 18.

As can be understood from this operation of the lever crank mechanism 20, when the swing end 18a of the swing link 18 moves away from the input shaft 2, the one-way clutch 17 which is the one-way rotation blocking mechanism in the stepless transmission 1 in this embodiment locks the swing link 18 to the output shaft 3 to transmit the drive force from the input shaft 2 to the output shaft 3.

In the lever crank mechanism 20, the distance Lcon between the input-side fulcrum and the output-side fulcrum satisfies the following conditional expression (1).

Lcon<√(Lp²+R1²−R2²) (1)

where the input-side fulcrum is the connecting point between the rotational radius adjusting mechanism 4 and the connecting rod 15, i.e. the center P3 of the rotary disc 6, the output-side fulcrum is the connecting point between the swing end 18a and the connecting rod 15, i.e. the center P5 of the connecting pin 19, Lp is the distance between the rotational center axis P1 of the input shaft 2 and the rotational center axis P4 of the output shaft 3, R1 is the distance between the rotational center axis P1 of the input shaft and the input-side fulcrum when the amount of eccentricity of the rotational radius adjusting mechanism 4 is a predetermined amount of eccentricity, and R2 is the distance between the rotational center axis P4 of the output shaft 3 and the output-side fulcrum.

Since the stepless transmission 1 in this embodiment is configured to satisfy the conditional expression (1), the angle between the connecting rod 15 and the swing link 18 is a right angle when the center P5 of the connecting pin 19 which is the output-side fulcrum is at the maximum load point as illustrated in FIG. 6D.

Therefore, the force applied to the swing link 18 by the connecting rod 15 at the time does not disperse in multiple directions and so vibrations can be suppressed, and also the output-side fulcrum can be prevented from being overloaded.

The stepless transmission 1 is also configured to satisfy the following conditional expression (2).

√(Lp²−R2²)−R1≦Lcon (2).

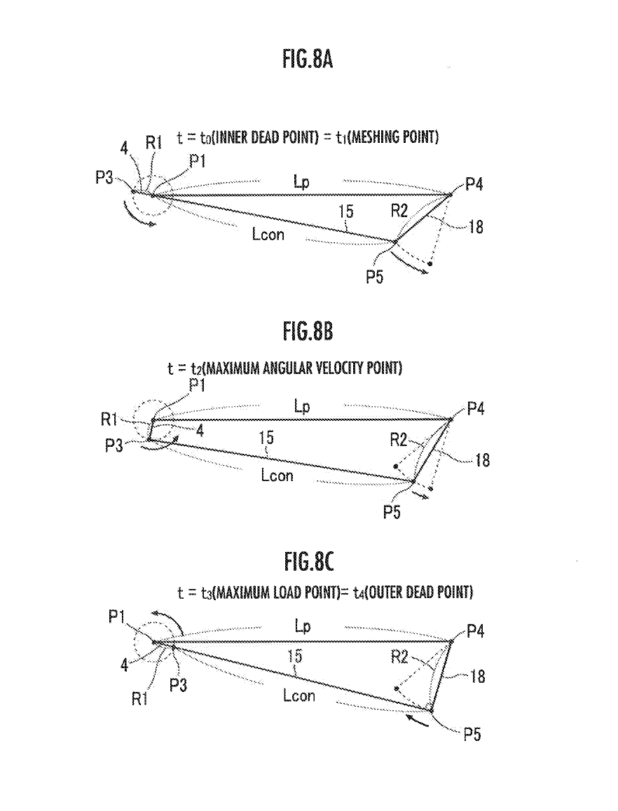

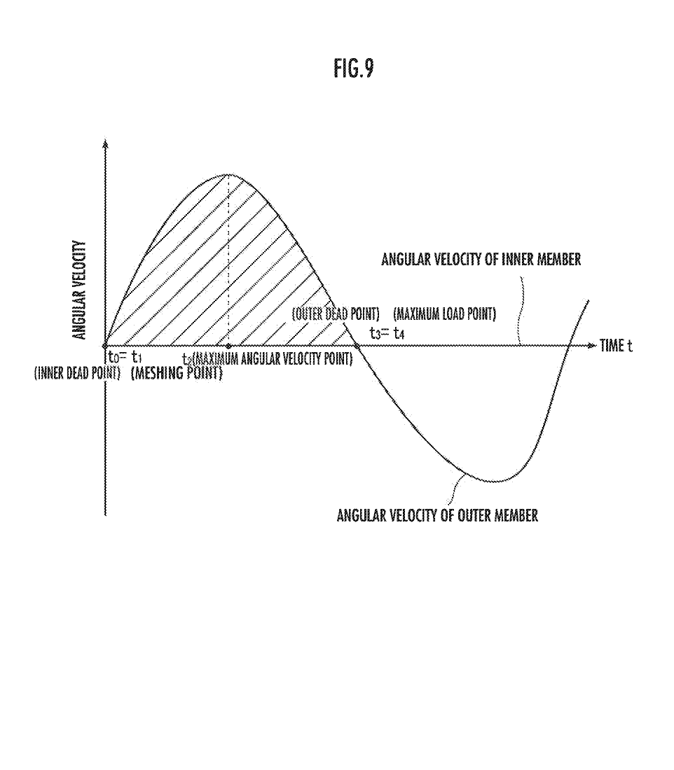

To explain the lower limit of the conditional expression (2), the operation of the lever crank mechanism 20 in the case where the angular velocity of the output shaft 3 which is the inner member of the one-way clutch 17 is 0 is described below, with reference to FIGS. 8A to 8C and 9.

First, as illustrated in FIG. 8A, when the center P3 of the rotary disc 6 (the input-side fulcrum) starts rotational motion, the center P5 of the connecting pin 19 (the output-side fulcrum) starts to move from the inner dead point in the direction away from the input shaft 2, and the angular velocity of the annular section 18d of the swing rink 18 which is the outer member of the one-way clutch starts to increase.

Since the angular velocity of the output shaft 3 which is the inner member of the one-way clutch 17 is 0, the inner dead point and the meshing point match, and the swing link 18 starts to transmit the torque to the output shaft 3 from the start of its swing motion. This is the state when t=t0=t1 in FIG. 9.

Next, as illustrated in FIG. 8B, when the center P3 of the rotary disc 6 (the input-side fulcrum) rotates to a certain extent, the center P5 of the connecting pin 19 (the output-side fulcrum) reaches the maximum angular velocity point, and the angular velocity of the annular section 18d starts to decrease. This is the state when t=t2 in FIG. 9.

Next, as illustrated in FIG. 8C, when the center P3 of the rotary disc 6 (the input-side fulcrum) further rotates, the center P5 of the connecting pin 19 (the output-side fulcrum) reaches the outer dead point and starts to move in the direction toward the input shaft 2, and the angular velocity of the annular section 18d of the swing rink 18 which is the outer member of the one-way clutch starts to increase in the negative direction.

Since the angular velocity of the output shaft 3 which is the inner member of the one-way clutch 17 is 0, the outer dead point and the maximum load point match, and the cumulative value (the hatched area in FIG. 9) of the torque transmitted to the output shaft 3 reaches a maximum when the direction of the swing motion of the swing link 18 is reversed. This is the state when t=t3=t4 in FIG. 9.

Subsequently, the center P3 of the rotary disc 6 (the input-side fulcrum) further rotates and the states in FIGS. 8A to 8C are repeated to perform the swing motion of the swing link 18.

In the lever crank mechanism 20 performing such a swing motion, the following conditional expression (2)′ is satisfied to form a right angle between the connecting rod 15 and the swing link 18 when the center P5 of the connecting pin 19 (the output-side fulcrum) reaches the outer dead point (the maximum load point).

√(Lp²−R2²)−R1=Lcon (2)′.

Since the maximum load point is never farther from the input shaft 2 than the outer dead point is, the minimum value of the length Lcon of the connecting rod 15 is “√(Lp²−R2²)−R1”.

Hence, the stepless transmission 1 in this embodiment is configured so that the length Lcon of the connecting rod 15 is greater than or equal to the value on the left side of the conditional expression (2)′, i.e. the length Lcon of the connecting rod 15 satisfies the conditional expression (2).

In the stepless transmission 1 in this embodiment in which the conditional expression (2) is satisfied in addition to the conditional expression (1), the length of the connecting rod 15 is appropriate regardless of the property of the one-way clutch 17.

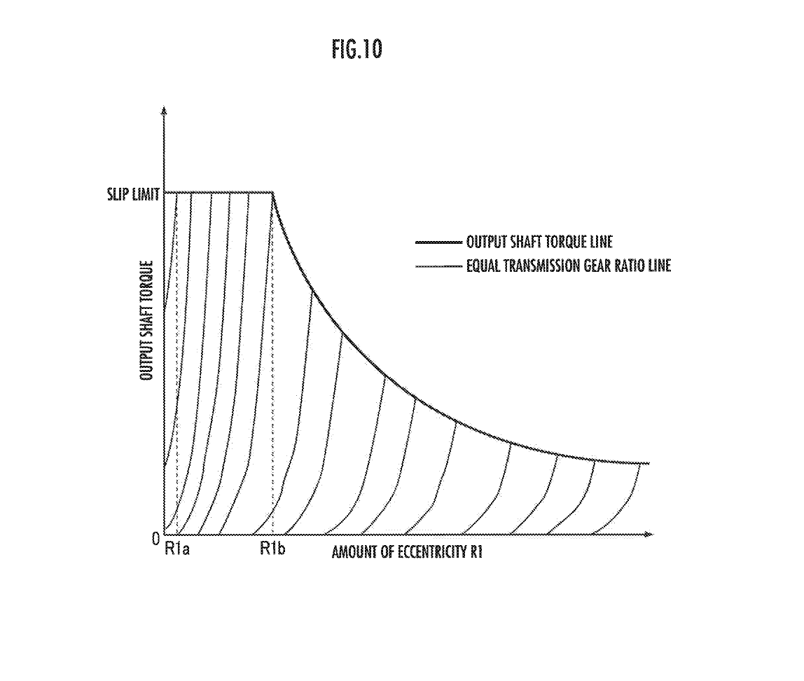

FIG. 10 is a graph illustrating changes in output shaft torque applied to the output shaft 3 with respect to changes in rotational radius of the rotational radius adjusting mechanism 4 in the case where the stepless transmission 1 in this embodiment is used in a typical vehicle or the like, depending on the property of the vehicle, etc.

In detail, in the case where the amount of eccentricity R1 is less than or equal to a predetermined value, the output shaft torque is a slip limit value determined by the coefficient of friction of each drive wheel of the vehicle or the like. The output shaft torque subsequently decreases as the amount of eccentricity R1 increases.

Even in the case where the output shaft torque is the slip limit value in FIG. 10, the number of lever crank mechanisms 20 among which the output shaft torque is shared is not always the same.

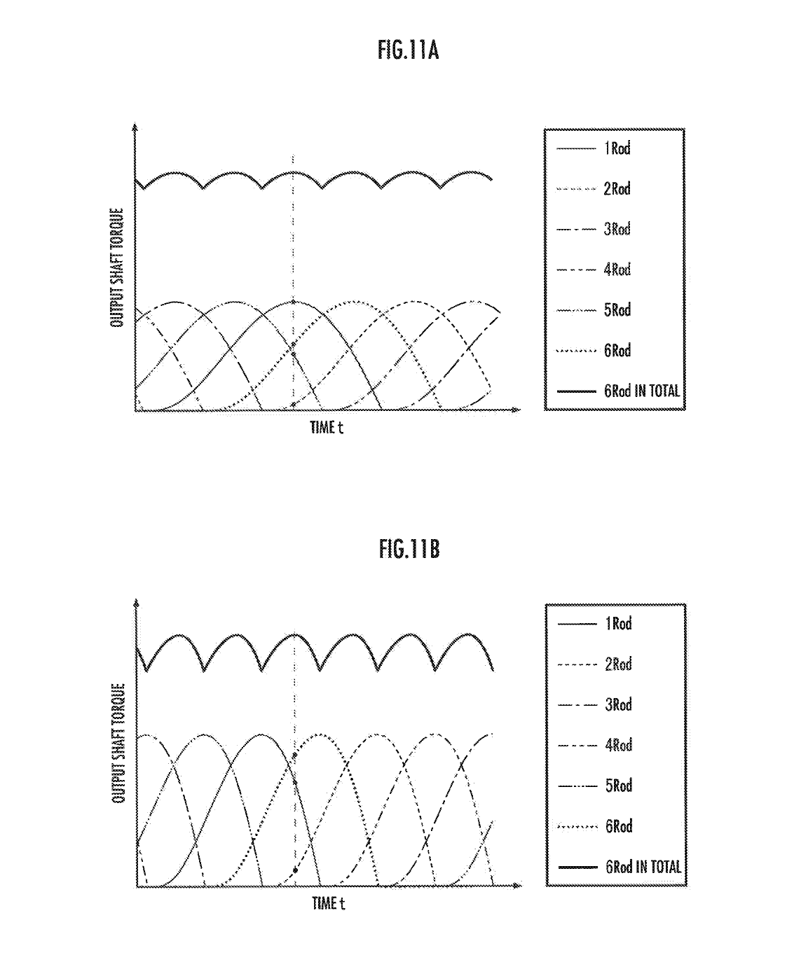

For example, in the case where the amount of eccentricity R1 is R1a which is close to 0, the number of lever crank mechanisms 20 among which the output shaft torque is shared at one point in time is four, as illustrated in FIG. 11A.

In the case where the amount of eccentricity R1 is R1b which is larger than R1a and is immediately before the output shaft torque starts to decrease, on the other hand, the number of lever crank mechanisms 20 among which the same output shaft torque as in FIG. 11A is shared is three, as illustrated in FIG. 11B.

Thus, the load assigned per lever crank mechanism 20 increases as the amount of eccentricity R1 increases.

Accordingly, in the case where the stepless transmission 1 in this embodiment is used in a vehicle or the like having the property as illustrated in FIG. 10, the amount of eccentricity R1 when the conditional expressions (1) and (2) are satisfied is set to R1b.

In other words, in the stepless transmission 1 in this embodiment, the predetermined amount of eccentricity R1 in the case where the conditional expression (1) is satisfied is the amount of eccentricity (Rib) when the transmission gear ratio i is maximum from among the amounts of eccentricity (0 to R1b) when the torque transmitted to the output shaft 3 is maximum.

Accordingly, the angle between the connecting rod 15 and the swing link 18 is a right angle in the state where the load applied to the output shaft 3 is largest and the number of lever crank mechanisms among which the load is shared is smallest. This minimizes the maximum load applied to the center P5 of the connecting pin 19, and suppresses vibrations.

### DESCRIPTION OF REFERENCE NUMERALS

1 stepless transmission
2 input shaft
2a cutout hole
3 output shaft (inner member)
4 rotational radius adjusting mechanism
5 cam disc
6 rotary disc
6a receiving hole
6b internal teeth
7 pinion shaft
7a external teeth
8 differential mechanism
8a differential mechanism case
9 sun gear
10 first ring gear
11 second ring gear
12 stepped pinion
12a large-diameter section
12b small-diameter section
13 carrier
14 adjustment drive source
14a rotating shaft
15 connecting rod
15a large-diameter annular section
15b small-diameter annular section
16 connecting rod bearing
17 one-way clutch (one-way rotation blocking mechanism)
18 swing link
18a swing end
18b protruding piece
18c through hole
18d annular section (outer member)
19 connecting pin
20 lever crank mechanism
i transmission gear ratio
Lcon length of connecting rod 15
Lp distance between P1 and P4
P1 rotational center axis of input shaft 2
P2 center of cam discs 5
P3 center of rotary disc 6 (input-side fulcrum)
P4 rotational center axis of output shaft 3
P5 center of connecting pin 19 (output-side fulcrum)
Ra distance between P1 and P2
Rb distance between P2 and P3
R1 distance between P1 and P3 (amount of eccentricity, rotational radius of
rotational radius adjusting mechanism 4)
R2 distance between P4 and P5 (length of swing link 18)
θ1 rotational angle of rotational radius adjusting mechanism 4
θ2 swing range of swing link 18

1-4. (canceled)

5. A stepless transmission comprising:
an input shaft to which a drive force of a drive source is transmitted;
an output shaft disposed in parallel with the input shaft;
a lever crank mechanism that includes: a rotational radius adjusting mechanism rotatable about the input shaft and having an adjustable rotational radius; a swing link pivotally supported by the output shaft; and a connecting rod connecting the rotational radius adjusting mechanism and the swing link, and that converts rotational motion of the input shaft into swing motion of a swing end of the swing link; and
a one-way rotation blocking mechanism that locks the swing link to the output shaft when the swing link rotates about the output shaft so that the swing end moves away from the input shaft, and lets the swing link idle with respect to the output shaft when the swing link rotates so that the swing end moves toward the input shaft,
wherein a distance Lcon between an input-side fulcrum and an output-side fulcrum is set so that an angle between a straight line passing through the input-side fulcrum and the output-side fulcrum and a straight line passing through a rotational center axis of the output shaft and the output-side fulcrum is a right angle at a time at which a torque accumulated in the output shaft when the swing link swings with a predetermined amount of eccentricity reaches a maximum, the input-side fulcrum being a connecting point between the rotational radius adjusting mechanism and the connecting rod, and the output-side fulcrum being a connecting point between the swing end and the connecting rod, and
wherein the distance Lcon satisfies the following conditional expressions
Lcon<√(Lp²+R1²−R2²)
√(Lp²−R2²)−R1≦Lcon
where Lp is a distance between a rotational center axis of the input shaft and the rotational center axis of the output shaft, R1 is a distance between the rotational center axis of the input shaft and the input-side fulcrum when an amount of eccentricity of the rotational radius adjusting mechanism is the predetermined amount of eccentricity, and R2 is a distance between the rotational center axis of the output shaft and the output-side fulcrum.

6. The stepless transmission according to claim 5, wherein the predetermined amount of eccentricity is an amount of eccentricity when a torque transmitted to the output shaft is maximum.

7. The stepless transmission according to claim 5, comprising
a plurality of the lever crank mechanisms,
wherein the predetermined amount of eccentricity is an amount of eccentricity when a transmission gear ratio is minimum, from among amounts of eccentricity when a torque transmitted to the output shaft is maximum.
